(19) United States
(12) Patent Application Publication
(10) Pub. No.: US 2025/0277957 A1
(43) Pub. Date: Sep. 4, 2025

(54) LENS UNIT

(71) Applicant: Atsushi NAKAMOTO, Kanagawa (JP)

(72) Inventor: Atsushi NAKAMOTO, Kanagawa (JP)

(21) Appl. No.: 18/858,767

(22) PCT Filed: Apr. 14, 2023
(86) PCT No.: PCT/IB2023/053812

§ 371 Date: Oct. 22, 2024

(30) Foreign Application Priority Data
Apr. 28, 2022 (JP) 2022-075143

(51) Int. Cl. G02B 7/02; G02B 1/04

(52) U.S. Cl. CPC G02B 7/026; G02B 1/041; G02B 7/021; G02B 7/022; G02B 7/028

(57) ABSTRACT

A lens unit includes: multiple lenses arranged in an axial direction along an optical axis, the multiple lenses including: a first lens group including a flat-reception lens having a flat surface perpendicular to the axial direction to be pressed; and a second lens group including an inclination-reception lens having an inclination surface inclined relative to the axial direction to be pressed, a lens barrel housing the multiple lenses inside the lens barrel; and an elastic member between the first lens group and the second lens group, the elastic member to support at least one of the multiple lenses in the lens barrel; and a pressing member to press the multiple lenses in the lens barrel.

### TECHNICAL FIELD

The present disclosure relates to a lens unit.

### BACKGROUND ART

A lens unit including multiple lenses, a lens barrel to house the multiple lenses, and a pressing member to press the multiple lenses housed in the lens barrel is known. Such a lens unit is used in a camera mounted on a mobile object such as an automobile or a drone, or a monitoring camera provided in a building.

For example, PTL 1 discloses a configuration of a lens unit including a lens barrel housing multiple lenses including a first lens disposed on a side of an object and a second lens adjacent to the first lens on a side of an image. Further, in the lens unit, an elastic member in contact with the first lens and the second lens is disposed between the first lens and the second.

However, in the configuration of the lens unit disclosed in PTL 1, there is a case where the performance of the lens unit changes by changing the shape or the position of the multiple lenses.

### CITATION LIST

### Patent Literature

### PTL 1

Japanese Unexamined Patent Application Publication No. 2021-140043

### SUMMARY OF INVENTION

### Technical Problem

An aim of the present invention is to provide a lens unit to reduce changes in the shapes or the positions of the multiple lenses.

### Solution to Problem

A lens unit includes: multiple lenses arranged in an axial direction along an optical axis, the multiple lenses including: a first lens group including a flat-reception lens having a flat surface perpendicular to the axial direction to be pressed; and a second lens group including an inclination-reception lens having an inclination surface inclined relative to the axial direction to be pressed, a lens barrel housing the multiple lenses inside the lens barrel; and an elastic member between the first lens group and the second lens group, the elastic member configured to support at least one of the multiple lenses in the lens barrel; and a pressing member configured to press the multiple lenses in the lens barrel.

Further, an embodiment of the present disclosure provides a lens unit including: multiple lenes arranged in an axial direction along an optical axis; a lens barrel housing the multiple lenses inside the lens barrel; an elastic member to support at least one of the multiple lenses in the lens barrel; and a pressing member to press the multiple lenses in the lens barrel. Herein, an expression (1) below is satisfied:

$$\vert K \times ( t \times ( {\sum }_{i = 1}^{n} ( α i \times Li ) - α 0 \times L 0 ) ) / F \vert < 0.1 , \qquad ( 1 )$$

where: K is an elastic modulus of the elastic member, F is an elasticity force to press the multiple lenses by elasticity of the elastic member, t is a range of ambient temperature in which the lens unit is allowed to use, n is a number of multiple lenses pressed by the elastic member with the elastic force of the elastic member, αi is a coefficient of linear expansion of each of the multiple lenses in the lens barrel pressed by the elastic member, Li is each of a length of the multiple lenses in the axial direction, α0 is a coefficient of linear expansion of the lens barrel, and L0 is a length of the lens barrel in the axial direction.

### Advantageous Effects of Invention

According to the embodiments of the present invention, a lens unit to reduce changes in the shapes or the positions of the multiple lenses.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a cross-sectional view of a configuration of a lens unit in a longitudinal direction according to a first embodiment:

FIG. 2A is a diagram of an inclination-reception lens without a positional movement;

FIG. 2B is a diagram of the inclination-reception lens with a positional movement;

FIG. 3A is a diagram of a supporting method of a six lens without a lens deformation according to a modification of the first embodiment;

FIG. 3B is a diagram of the supporting method of the six lens with a lens deformation according to the modification of the first embodiment;

FIG. 4 is a graph of an evaluation result of the amount of the movement of each lens of the rear lens group of the lens unit in FIG. 1 for each temperature cycle;

FIG. 5 is an enlarged view of a fourth lens and a fifth lens in the lens unit in FIG. 1;

FIG. 6 is a cross-sectional view of a configuration of a lens unit in a longitudinal direction according to a second embodiment;

FIG. 7 is a cross-sectional view of a configuration of a lens unit in a longitudinal direction according to a first example of a third embodiment.

FIG. 8 is a cross-sectional view of a configuration of a lens unit in a longitudinal direction according to a second example of the third embodiment.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A lens unit according to an embodiment of the present invention will be described in detail with reference to the drawings. The following embodiment is an example of a lens unit for embodying the technical idea of the present embodiment, and is not limited thereto. Unless otherwise specified, shapes of components, relative arrangements thereof, and values of parameters described below are not intended to limit the scope of the present invention but are intended to exemplify the scope of the present invention. The relative positions or the size of the elements illustrated in the drawings may be exaggerated for purpose of clear illustration. In the following description, common or corresponding elements are denoted by the same or similar reference signs, and redundant description is appropriately simplified or omitted.

### First Embodiment

### Example of Lens Unit

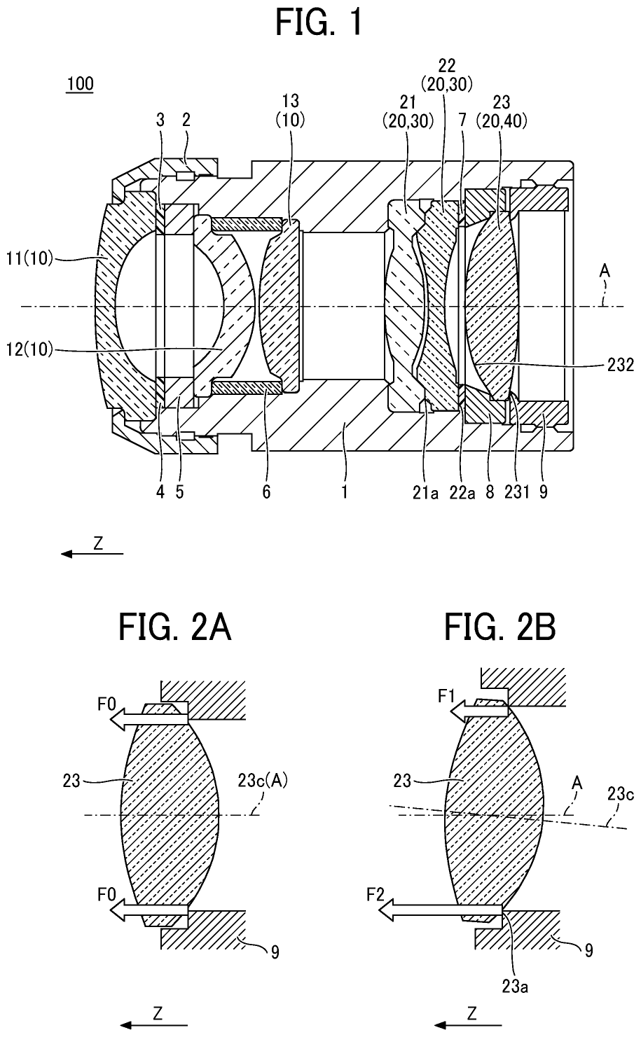

FIG. 1 is a cross-sectional view of a configuration of a lens unit in a longitudinal direction according to a first embodiment. The lens unit 100 includes a front lens group 10, a rear lens group 20, a lens barrel 1, and a front lens pressing member 2. The lens unit 100 also includes a front lens shielding member 3, a front lens elastic member 4, a first front lens spacer 5, a second front lens spacer 6, an elastic member 7, an intervening member 8, and a pressing member 9.

The front lens group 10 includes a first lens 11, a second lens 12, and a third lens 13. The rear lens group 20 includes a fourth lens 21, a fifth lens 22, and a sixth lens 23.

The first lens 11, the front lens shielding member 3, the front lens elastic member 4, the first front lens spacer 5, the second lens 12, the second front lens spacer 6, and the third lens 13 are arranged in this order from the positive Z-direction to the negative Z-direction along the Z-axis and housed in the lens barrel 1. The fourth lens 21, the fifth lens 22, the elastic member 7, the intervening member 8, and the sixth lens 23 are arranged in this order from the positive Z-direction to the negative Z-direction and housed in the lens barrel 1.

The positive Z-direction is the direction in which the arrow indicating the Z-axis in the drawings is directed, and corresponds to the direction in which a subject of the lens unit 100 is located. The negative Z-direction indicates the direction opposite to the positive Z-direction and corresponds to a direction in which an image of the subject is located.

The front lens pressing member 2 has a screw portion at an inner portion of the front lens pressing member 2. The lens barrel 1 includes a screw portion at a part of an outer portion in the positive Z-direction. The first lens 11, the front lens shielding member 3, the front lens elastic member 4, the first front lens spacer 5, the second lens 12, the second front lens spacer 6, and the third lens 13 are pressed by coupling the screw portion of the front lens pressing member 2 and the screw portion of the lens barrel 1. In the lens unit 100, each member described above is fixed by pressing by the front lens pressing member 2.

The pressing member 9 has a screw portion at an outer portion of the pressing member 9. The lens barrel 1 has a screw portion at a part of an inner portion in the negative Z-direction. The fourth lens 21, the fifth lens 22, the elastic member 7, the intervening member 8 and the sixth lens 23 are pressed by coupling the screw portion of the pressing member 9 and the screw portion of the lens barrel 1. In the lens unit 100, each member described above is fixed by pressing by the pressing member 9.

However, the fixing of each member to the lens barrel 1 is not limited to using the coupling of the screw portion in the front lens pressing member 2 or the pressing member 9, and may be performed by heat caulking or adhesion.

The fourth lens 21, fifth lens 22, and sixth lens 23 in the rear lens group 20 correspond to multiple lenses arranged along the optical axis A. The elastic member 7 supports the sixth lens 23 housed in the lens barrel 1. Herein, the lens unit 100 may include multiple elastic members, and the multiple elastic members may support the multiple lenses housed in the lens barrel 1.

In the fourth lens 21, the flat portion 21a is pressed by the pressing member 9 via the sixth lens 23, the intervening member 8, the elastic member 7 and the fifth lens 22. In the fifth lens 22, the flat portion 22a is pressed by the pressing member 9 via the sixth lens 23, the intervening member 8, the elastic member 7 and the fifth lens 22. The flat portion 21a and the flat portion 22a are substantially perpendicular to the optical axis A. A lens having a surface or a portion of the surface perpendicular to the optical axis and pressed is referred to as a flat-reception lens. Thus, each of the fourth lens 21 and the fifth lens 22 is the flat-reception lens in which a surface substantially perpendicular to the optical axis A is pressed.

The sixth lens 23 is a biconvex lens having a first spherical surface 231 and a second spherical surface 232. In the sixth lens 23, the first spherical surface 231 is pressed by the pressing member 9. The first spherical surface 231 is inclined with respect to the optical axis A. A lens having a surface or a portion of the surface inclined with respect to the optical axis and pressed is referred to as an inclination-reception lens. Thus, the six lens is the inclination-reception lens.

In some embodiment, in the lens unit, the inclination surface of the inclination-reception lens is spherical.

The intervening member 8 is disposed in contact with the elastic member 7 on a plane substantially perpendicular to the optical axis A while supporting the sixth lens 23. The sixth lens 23 is a supported lens supported by the elastic member 7 among the multiple lenses. The intervening member 8 is fitted into the lens barrel 1 and works as a regulating member to regulate the length of the elastic member 7 in the direction along the optical axis A. In some embodiments, the lens unit, further includes: an intervening member having a surface perpendicular to the axial direction, the surface contacting the elastic member. The intervening member supports the inclination-reception lens, the elastic member supports the inclination-reception lens via the intervening member, and the inclination-reception lens has the inclination surface facing the flat-reception lens of the first lens group and inclined relative to the axial direction.

In the intervening member 8, the surface substantially perpendicular to the optical axis A is pressed. The elastic member 7 supports the sixth lens 23 via the intervening member 8. The second spherical surface 232 of the sixth lens 23 facing the elastic member 7 is inclined with respect to the optical axis A.

In the present embodiment, the length of the elastic member 7 in the direction along the optical axis A is substantially constant while the pressing member 9 presses the elastic member 7.

The fourth lens 21, the fifth lens 22, and the sixth lens 23 include the flat-reception lens and the inclination-reception lens. Among these lenses, the fourth lens 21 and the fifth lens 22 configure a first lens group 30 including the flat-reception lens. The sixth lens configures a second lens group 40 including the inclination-reception lens. The first lens group 30 may include the flat-reception lens other than the fourth lens 21 and the fifth lens 22. The second lens group 40 may include the inclination-reception lens other than the sixth lens 23. In some embodiments, a lens unit includes: multiple lenses arranged in an axial direction along an optical axis, the multiple lenses including: a first lens group including a flat-reception lens having a flat surface perpendicular to the axial direction to be pressed; and a second lens group including an inclination-reception lens having an inclination surface inclined relative to the axial direction to be pressed, a lens barrel housing the multiple lenses inside the lens barrel; and an elastic member between the first lens group and the second lens group, the elastic member to support at least one of the multiple lenses in the lens barrel; and a pressing member to press the multiple lenses in the lens barrel.

The elastic member 7 is disposed between the first lens group 30 and the second lens group 40.

Each of the lenses in the front lens group 10 and the rear lens group 20 contains a glass material or a resin material. The front lens pressing member 2, the front lens shielding member 3, the first front lens spacer 5, the second front lens spacer 6, the intervening member 8 and the pressing member 9 contain a metal material, a resin material, or a combination thereof. The front lens elastic member 4 and the elastic member 7 include a plate spring, a coil spring, a rubber material, or an adhesive, which contain a metal material or a resin material.

### Operation and Effect of Lens Unit

Each lens in the front lens group 10 and the rear lens group 20 is positioned and fixed with respect to the lens barrel 1 or a member supported by the lens barrel 1. As a method of positioning and fixing the lens, press fitting, gap fitting, or adhesion can be appropriately selected according to the application.

When a load is applied to the lens at the time of press fitting, the lens may be broken or rubbed by foreign matter, and the performance may decrease. Further, in an application such as an in-vehicle application, since the temperature variation range of the use environment of the lens unit 100 is wide, a load due to expansion or contraction is applied, and each part of the lens unit 100 may be damaged.

By contrast, in bonding, there are cases in which the lens becomes cloudy due to gas generated from the adhesive, or the adhesive is peeled off due to expansion or contraction of the adhesive, the lens, or the lens barrel, and each part of the lens unit 100 may be damaged.

As described above, when the lens unit 100 is used for an application such as an in-vehicle application in which the temperature variation range of the use environment is wide, it is preferable to use gap fitting as a lens positioning method and a lens fixing method. However, in the clearance fitting, since there is a gap between the lens and the lens barrel 1 or the elastic member 7 supporting the lens in the radial direction, the lens may be displaced and decentered in the radial direction at the time of expansion or contraction.

Further, a spherical lens such as the sixth lens 23 is a low-lost lens because the shape of the spherical lens is simpler than that of an aspherical lens. However, in a case where a surface inclined with respect to the optical axis A of the first spherical surface 231 is pressed, the spherical lens may be deformed, and the position may move due to change of the pressing state. FIG. 2A is a diagram of an inclination-reception lens without a positional movement. FIG. 2B is a diagram of an inclined-receiving lens with a positional movement.

In FIG. 2A, the optical axis 23c of the sixth lens 23 substantially coincides with the optical axis A of the lens unit 100. The pressing force F0 from the pressing member 9 to the sixth lens 23 is substantially symmetric with respect to the optical axis 23c of the sixth lens 23. The pressing force applied to the fifth lens 22 and the fourth lens 21 via the sixth lens 23 based on the pressing force F0 is substantially symmetrical with respect to the optical axis A.

By contrast, as illustrated in FIG. 2B, there is a case where the sixth lens 23 is inclined with respect to the lens barrel as an inclined state. In FIG. 2B, the optical axis 23c of the sixth lens 23 is inclined with respect to the optical axis A. When the sixth lens 23 is inclined, the pressing force of the pressing member 9 becomes asymmetric with respect to the optical axis A. For example, the pressing force F1 is applied to a portion of the sixth lens 23, and the pressing force F2 larger than the pressing force F1 is applied to another portion of the sixth lens 23. As a result, the pressing force applied to the fifth lens 22 and the fourth lens 21 via the sixth lens 23 based on the pressing force F1 and the pressing force F2 is asymmetric with respect to the optical axis A (i.e., asymmetric pressing force).

When the lens unit expands or contracts in response to changes in ambient temperature around the lens unit while the asymmetric pressing force with respect to the optical axis A is applied, each lens in the lens unit may individually move in the radial direction thereof and be decentered. Since the lens is decentered, aberrations such as coma aberration and distortion occurs, and the performance of the lens unit changes.

For example, a surface substantially perpendicular to the optical axis A in a region other than the optically effective region of the lens is formed so that the asymmetric pressing force with respect to the optical axis A is not applied and press the surface. In such a way, the positional movement caused by the asymmetric pressing force with respect to the optical axis A can be prevented. However, the cost of forming the surface substantially perpendicular to the optical axis increases. Further, if the lens has a processing allowance region (i.e., processing allowance) in order to form a surface substantially perpendicular to the optical axis A, the thickness of the lens is increased, and there may be a restriction in the design of the lens unit 100. Further, in order to form a surface substantially perpendicular to the optical axis A on the outside of the optically effective surface of the lens, the outer diameter of the lens also increases, and there may be a restriction on the layout.

In the present embodiment, as described with reference to FIG. 1, the elastic member 7 is disposed between the first lens group 30 and the second lens group 40. Thus, even if the pressing force applied to the second lens group 40 including the sixth lens 23 is asymmetric with respect to the optical axis A, the pressing force is substantially absorbed by the elastic member 7 and is not substantially transmitted to the first lens group 30. Thus, the decentering of the first lens group 30 can be reduced because the asymmetric pressing force with respect to the optical axis A is applied to the first lens group 30.

In some embodiments, in the lens unit, the multiple lenses including: a first lens group including a flat-reception lens having a flat surface perpendicular to the axial direction to be pressed; and a second lens group including an inclination-reception lens having an inclination surface inclined relative to the optical axis to be pressed. The elastic member is between the first lens group and the second lens group.

In the sixth lens 23, since the first spherical surface 231 is pressed, the movement in the radial direction thereof is reduced by the pressing force. Thus, even if there is a change in the ambient temperature around the lens unit, the lens unit hardly moves.

As a result, according to the present embodiment, the lens unit 100 that reduces changes in the shapes or the positions of the multiple lenses. In the present embodiment, a change in performance of the lens unit 100 is reduced by reducing a change in shape or position of the multiple lenses.

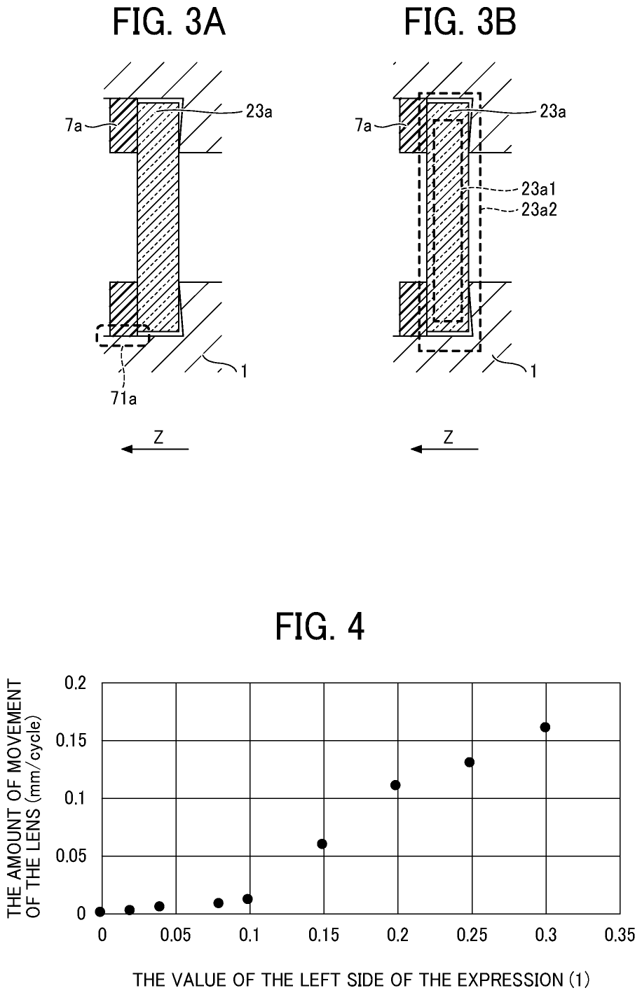

FIGS. 3A and 3B are diagrams of a supporting method of the six lens without a lens deformation according to a modification of the first embodiment. FIG. 3A is a diagram of a supporting method of the sixth lens 23a without a lens deformation, and FIG. 3B is a diagram of a supporting method of the sixth lens 23a with a lens deformation.

In FIG. 3, the sixth lens 23a is housed in the lens barrel 1 and supported by a support member 7a. The support member 7a has a screw portion in the region 71a, and is fixed to the lens barrel 1 via the screw portion by, for example, coupling. The fixing of the support member 7a is not limited to the fixing by the coupling of the screw portion, but may be performed by heat caulking or adhesion.

The sixth lens 23a contains, for example, a resin material such as polycarbonate (PC) or glass. The lens barrel 1 contains, for example, a metal material such as aluminum or a resin material such as poly phenylene sulfide (PPS). Thus, the material of the sixth lens 23a and the material of the lens barrel 1 are different. Since the coefficient of linear expansion differs depending on materials, the amount of the expansion and the amount of the reduction of the sixth lens 23a and the lens barrel 1 differ when the ambient temperature changes.

In FIG. 3B, the sixth lens 23a1 is relatively contracted with respect to the lens barrel 1. By contrast, the sixth lens 23a2 is relatively expanded with respect to the lens barrel 1.

When the coefficient of linear expansion of the sixth lens 23a is smaller than the coefficient of linear expansion of the lens barrel 1, the amount of expansion of the sixth lens 23a due to an increase in the ambient temperature around the lens unit is relatively smaller than the amount of expansion of the lens barrel 1. Thus, the sixth lens 23a similar to the sixth lens 23a1 becomes relatively small with respect to the lens barrel 1, and the supporting force of the support member 7a is reduced.

By contrast, the amount of contraction of the sixth lens 23a due to a decrease in the ambient temperature becomes relatively small with respect to the amount of contraction of the lens barrel 1. Thus, the sixth lens 23a similar to the sixth lens 23a2 becomes relatively large with respect to the lens barrel 1, and the supporting force by the support member 7a increases. When the coefficient of linear expansion of the sixth lens 23a is larger than the coefficient of linear expansion of the lens barrel 1, an opposite effect can be obtained. In other words, the supporting force of the support member 7a changes depending on the ambient temperature around the lens unit.

When the material of the sixth lens 23a is a resin, since the Young's modulus of the resin is lower, the sixth lens 23a is easily deformed by the supporting force. Thus, when the supporting force changes at the time of change of the ambient temperature around the lens unit, the amount of the deformation of the sixth lens 23a also changes, and the performance of the sixth lens 23a largely changes. In addition, since a creep phenomenon occurs in a high-temperature environment, the performance of supporting decreases with time. Thus, the amount of the deformation of the sixth lens 23a is changed, and the performance of the sixth lens 23a is changed.

When the material of the sixth lens 23a is glass, since the glass is harder than the resin, the amount of the deformation of the glass is smaller than that of the resin, so that the influence on the performance of the sixth lens 23a is small. However, since glass is easily broken, the sixth lens 23a may be broken and damaged when the supporting force of the sixth lens 23a is increased.

For example, when a member having elasticity is used as the support member 7a, even if the relative size of the sixth lens 23a with respect to the lens barrel 1 changes due to a change in the ambient temperature around the lens unit 100, the support member 7a can absorb the change in size due to the elasticity thereof. As a result, in the lens unit 100, the lens deformation and lens breakage caused by changes in supporting force due to expansion and contraction of members is reduced at the time of temperature change.

Further, as described above, when the sixth lens 23a is supported by the elastic member 7, and the ambient temperature around the lens unit changes, a change in the pressing force applied from the pressing member 9 can be reduced. However, when the elastic member 7 is used, and the ambient temperature changes, the pressing force applied from the pressing member 9 changes according to the elastic coefficient of the elastic member 7. The movement in the radial direction is reduced by a frictional force generated according to the pressing force. When the ambient temperature around the lens unit changes, the frictional force also changes according to the change in the pressing force. The lens may move in the radial direction according to such a change in friction force and a difference in the amount of expansion and the amount of contraction caused by the difference in the coefficient of linear expansion between the members. As a result, the performance of the lens unit may change.

As a result of intensive studies conducted by the inventor, the decentering of the lens caused by repeated changes in the ambient temperature can be reduced by using the elastic member 7 satisfying an expression (1) below.

$$\vert K \times ( t \times ( {\sum }_{i = 1}^{n} ( α i \times Li ) - α 0 \times L 0 ) ) / F \vert < 0.1 \qquad ( 1 )$$

In the expression (1):
K (N/mm) is the elastic modulus of the elastic member 7,
F (N) is an elastic force of the elastic member 7 to press each of the fourth lens 21, the fifth lens 22, and the sixth lens 23 by its elasticity,
T(° C.) is an ambient temperature range in which the lens unit 100 can be used, n is the number of members that are pressed mainly by the elastic force of the elastic member 7,
αi (1/° C.) is the coefficient of linear expansion of each of the fourth lens 21 and the fifth lens 22, the fourth lens 21 and the fifth lens 22 correspond to multiple housing members that are housed in the lens barrel 1 and are pressed mainly by the elastic force of the elastic member 7 (Herein, the fourth lens 21 and the fifth lens 22 are simply referred to as multiple housing members.),
Li (mm) is a length of each of the multiple housing members in the direction along the optical axis A, and i is a natural number,
α0 (1/° C.) is the coefficient of linear expansion of the lens barrel 1, and
L0 (mm) is a length of the lens barrel 1 in a direction along the optical axis A, and L0=ΣLi.

In some embodiments, a lens unit includes: multiple lenes arranged in an axial direction along an optical axis; a lens barrel housing the multiple lenses inside the lens barrel;
an elastic member to support at least one of the multiple lenses in the lens barrel; and a pressing member to press the multiple lenses in the lens barrel. Herein, an expression (1) below is satisfied:

$$\vert K \times ( t \times ( {\sum }_{i = 1}^{n} ( α i \times Li ) - α 0 \times L 0 ) ) / F \vert < 0.1 , \qquad ( 1 )$$

where: K is an elastic modulus of the elastic member,
F is an elasticity force to press the multiple lenses by elasticity of the elastic member,
t is a range of ambient temperature in which the lens unit is allowed to use,
n is a number of multiple lenses pressed by the elastic member with the elastic force of the elastic member,
αi is a coefficient of linear expansion of each of the multiple lenses in the lens barrel pressed by the elastic member,
Li is each of a length of the multiple lenses in the axial direction,
α0 is a coefficient of linear expansion of the lens barrel, and
L0 is a length of the lens barrel in the axial direction.

FIG. 4 is a graph of an evaluation result of the amount of the movement of each lens in the rear lens group of the lens unit in FIG. 4 for each temperature cycle by simulation. The horizontal axis in FIG. 4 indicates the value of the left side in the expression (1). The vertical axis in FIG. 4 is the amount of the movement of the lens in the radial direction per temperature cycle.

In the simulation, the temperature cycle was executed 30 times, and the inclination was calculated from the amount of the movement of the first and last lens. As the temperature cycle, one cycle includes normal temperature, the lower limit of expected use temperature range (e.g., −40° C.), the upper limit of expected use temperature range (e.g., 105° C.), and the normal temperature in this order.

The fourth lens 21 and the fifth lens 22 are housed in a lens barrel 1. The fifth lens has a surface that faces the image. An elastic force F from the elastic member 7 is applied to the surface of the fifth lens 22. When the ambient temperature changes, the pressing force is changed in consideration of the amount of change in the pressing force obtained by multiplying the difference between the amount of change in the length of the lens barrel 1 in the direction along the optical axis A and the amount of change in the lengths of the fourth lens 21 and the fifth lens 22 in the direction along the optical axis A by an elastic constant K.

According to the result in FIG. 4, when the value on the left side of expression (1) exceeds about 0.1, the amount of movement of the lens in the radial direction rapidly increases.

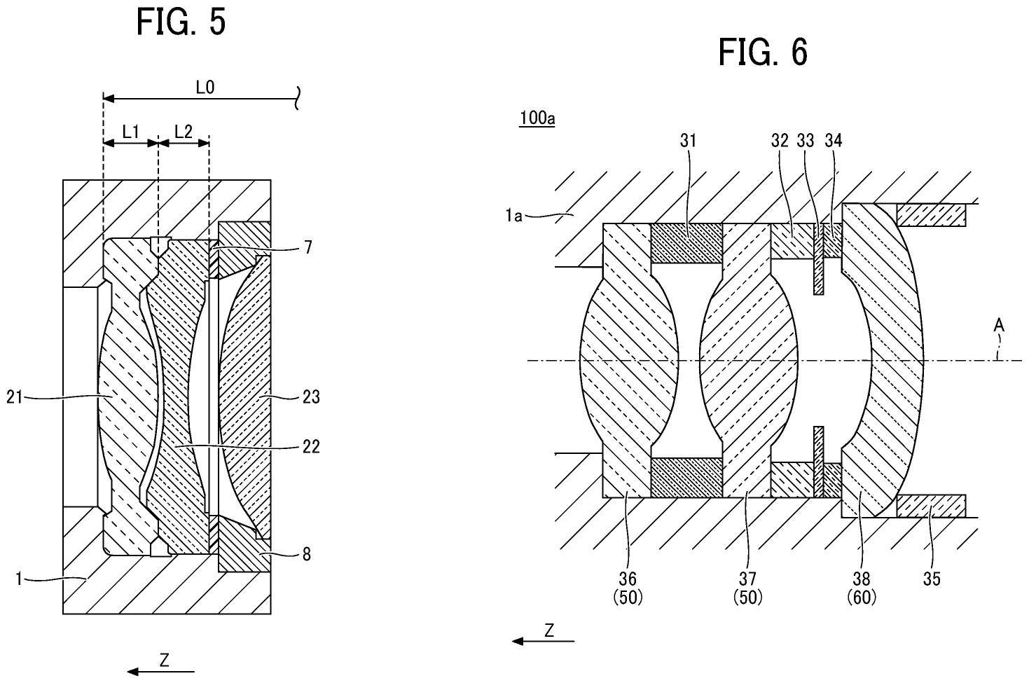

FIG. 5 is an enlarged view of the fourth lens 21 and the fifth lens 22 in the lens unit 100 in FIG. 1. For example, the fourth lens 21 and the fifth lens 22 is made of resin, and the lens barrel 1 is made of metal, for example, aluminum. When the values of the variables and constants below are substituted into the expression (1) described above, the value of the left side of the expression (1) is 0.031 and less than 0.1. Thus, the expression (1) is satisfied.
Elastic modulus of the elastic member 7: K=12 (N/mm)
Elastic force of the elastic member 7: F=7 (N)
Coefficient of linear expansion the fourth lens 21: α1=60×10⁻⁶ (1/° C.)
Length of the fourth lens 21: L1=2 (mm)
Coefficient of the linear expansion of the fifth lens 22: α2=66×10⁻⁶ (1/° C.)
Length of the fifth lens 22: L2=2 (mm)
Coefficient of linear expansion of the lens barrel 1: α0=24×10⁻⁶ (1/° C.)
Length of the lens barrel 1: L0=4 (mm)
Ambient temperature range: t=115 (° C.) (−30° C. to 85° C.)

The elastic member 7 includes a plate-shaped spring member made of, for example, a metal material. Specifically, the elastic member 7 is a wave washer made of stainless steel (SUS). The wave washer has an outer diameter of 13 mm, an inner diameter of 9 mm, a thickness of 0.1 mm, the number of wave of three, a free length of 1.1 mm, and a length of 0.5 mm in a direction along the optical axis A of the elastic member 7 when the elastic member 7 is contracted at a constant rate.

Material such as stainless steel is used for the elastic member 7 because an effect on creep of the metal under a high-temperature environment is smaller than that of resin or rubber. When the material of the elastic member 7 is resin or rubber, creep increases under a high-temperature environment, and the elastic force decreases with time, so that the sixth lens 23 may not be stably supported. By contrast, since the elastic member 7 includes a metal material, the elastic member 7 can stably support the sixth lens 23. Thus, in the present embodiment, the lens unit 100 that reduces changes in the shapes or positions of multiple lenses and maintains preferable performance of the lens unit 100 over a long period of time can be provided.

In some embodiments, in the lens unit, the elastic member includes a flat spring containing a metal material.

In the present embodiment, the length of the elastic member 7 in the direction along the optical axis A is substantially constant while the pressing member 9 presses the elastic member 7. Thus, the elastic force of the elastic member 7 is substantially constant, and each component of the lens unit 100 can be stabilized so that the position thereof does not change. Further, since the length of the elastic member 7 in the direction along the optical axis A is limited, the distance between the fifth lens 22 and the sixth lens 23 can be substantially constant, and the performance of the lens unit 100 can be stabilized.

In some embodiments, in the lens unit, a length of the elastic member in the axial direction is constant in a state where the elastic member is pressed by the pressing member.

In the present embodiment, the lens unit 100 includes an intervening member 8 that is in contact with the elastic member 7 in a surface substantially perpendicular to the optical axis A. The elastic member 7 supports the sixth lens 23 (supported lens) via an intervening member 8. The second spherical surface 232 of the sixth lens 23 faces the elastic member 7 and is inclined with respect to the optical axis A.

For example, when the elastic member 7 and the second spherical surface 232 of the sixth lens 23 is in contact with each other, the second spherical surface 232 of the sixth lens 23 is inclined with respect to the optical axis A, so that the pressing force may become asymmetric with respect to the optical axis A (i.e., asymmetric pressing force).

In the present embodiment, since the lens unit 100 supports the sixth lens 23 via the elastic member 7 and the intervening member 8 in contact with the elastic member 7 on a surface substantially perpendicular to the optical axis A, the pressing force is substantially symmetric with respect to the optical axis A. Thus, the movement of the lens caused by the asymmetric pressing force with respect to the optical axis A is reduced, and the performance of the lens unit 100 is less likely to change.

In order to obtain stable elastic force of the elastic member 7 and stable optical performance of the lens unit 100, it is preferable that the intervening member 8 is in contact with the lens barrel 1. Thus, it is preferable that the pressing force applied by the pressing member 9 via the sixth lens 23 by the intervening member 8 is increased with respect to the elastic force when the sixth lens 23 is supported by the elastic member 7.

In the present embodiment, the fourth lens 21, the fifth lens 22, and the sixth lens 23 (i.e., the multiple lenses) may include at least one resin lens made of resin. The cost of the lens unit 100 can be reduced by using the resin lens.

In some embodiments, in the lens unit, the multiple lens includes at least one resin lens.

### Second Embodiment

Next, a lens unit according to a second embodiment will be described. In the second embodiment, the same components as those in the first embodiment are denoted by the same reference numerals, and redundant description thereof is appropriately omitted. However, for the sake of convenience, the same name may be used for the component (e.g., first lens) whose name includes a number indicating the order even if the component is different from the first embodiment. These points are the same in the following embodiments.

FIG. 6 is a cross-sectional view of a configuration of a lens unit in a longitudinal direction according to a second embodiment. A lens unit 100a includes a first lens group 50, a second lens group 60, a first intervening member 31, a second intervening member 32, a light shielding member 33, an elastic member 34, and a pressing member 35. The first lens group 50 includes a first lens 36, a second lens 37, and a third lens 38.

The first lens 36, the first intervening member 31, the second lens 37, the second intervening member 32, the light shielding member 33, the elastic member 34, the third lens 38, and the pressing member 35 are arranged in this order from the positive Z-direction to the negative Z-direction.

The pressing member 35 has a screw portion at an outer portion of the pressing member 35. The lens barrel 1a has a screw portion at a part of an inner portion in the negative Z-direction. Each member housed in the lens barrel 1b is fixed by coupling the screw portions of the pressing member 35 and each screw portion of the lens barrel 1b.

The first lens 36 and the second lens 37 supported by the elastic member 34 correspond to a flat-reception lens in which surfaces substantially perpendicular to the optical axis A are pressed. In the third lens 38 pressed by the pressing member 35, one surface facing the elastic member 34 (i.e., facing the positive Z-direction) is a flat surface, and the other surface facing the pressing member 35 (i.e., facing the negative Z-direction) is a spherical surface. Thus, the third lens 38 is the inclination-reception lens.

The third lens 38 is positioned and fixed by clearance fitting. The third lens 38 has a gap in the radial direction. Thus, when the third lens 38 is displaced and disposed, the third lens 38 is inclined and in contact with the pressing member 35. The pressing force of the pressing member 35 is asymmetric with respect to the optical axis A. The third lens 38 works as a regulating member to regulate the length of the elastic member 34 in the direction along the optical axis A.

In the case where the material of the elastic member 34 is metal, and the light incident from the positive Z-direction is reflected by the elastic member 34, the light is repeatedly regularly reflected (i.e., regular reflection light) or repeatedly diffused (i.e., diffuse reflection light) and enters the image sensor arranged on the image side of the lens unit 100a. Such the regular reflection light or the diffuse reflection light becomes flare or ghost in a photographed image.

In the present embodiment, the flare light or the ghost light described above is less likely to generate by disposing the light shielding member 33 at a position adjacent to the elastic member 34, Instead of providing the light shielding member 33, the elastic member 34 may be coated or plated to reduce the luster peculiar to metal so that the specular reflection light or the diffuse reflection light from the elastic member 34 is reduced.

For example, the first lens 36 is made of glass, and the second lens 37 is made of resin. Further, the lens barrel 1a, the first intervening member 31 and the second intervening member 32 are made of a metal such as aluminum, and the light shielding member 33 is made of a metal, particularly stainless steel. When the values of the variables and constants below are substituted into the expression (1) described above, the left side of the expression (1) is 0.020 and less than 0.1.

Thus, the expression (1) is satisfied.
Elastic modulus of the elastic member 34: K=43 (N/mm)
Elastic force of the elastic member 34: F=17 (N)
Coefficient of linear expansion of the first lens 36: a1=10×10⁻⁶ (1/° C.)
Length of the first lens 36: L1=2 (mm)
Coefficient of linear expansion of the first intervening member 31: α2=24×10⁻⁶ (1/° C.)
Length of the first intervening member 31: L2=3 (mm)
Coefficient of linear expansion of the second lens 37: α3=66×10⁻⁶ (1/° C.) Length of the second lens 37: L3=2 (mm)
Coefficient of linear expansion of the second intervening member 32: α4=24×10⁻⁶ (1/° C.)
Length of the second intervening member 32: L4=1.5 (mm)
Coefficient of linear expansion of the light shielding member 33: α5=19×10⁻⁶ (1/° C.)
Length L5 of the light shielding member 33=0.03 (mm)
Coefficient of linear expansion of the lens barrel 1a: α0=24×10⁻⁶ (1/° C.)
Length of the lens barrel 1a: L0=8.53 (mm)
Ambient temperature range: t=145 (° C.) (−40° C. to 105° C.)

The elastic member 34 includes a plate-shaped spring containing, for example, a metal material. Specifically, the elastic member 34 is a wave washer made of stainless steel (SUS). The wave washer has an outer diameter of 16 mm, an inner diameter of 12 mm, a thickness of 0.2 mm, the number of wave of three, a free length of 0.8 mm, and a length of 0.4 mm in a direction along the optical axis A of the elastic member 34 when the elastic member 34 is contracted at a constant rate.

When the pressing force by the pressing member 35 is set to 100 N, the pressing force is larger than the elastic force of 17 N of the elastic member 34, so that the third lens 38 can be abutted against the lens barrel 1a. In the present embodiment, the same operation and effect as those of the first embodiment can also be obtained.

Third Embodiment Next, a lens unit according to a third embodiment will be described.

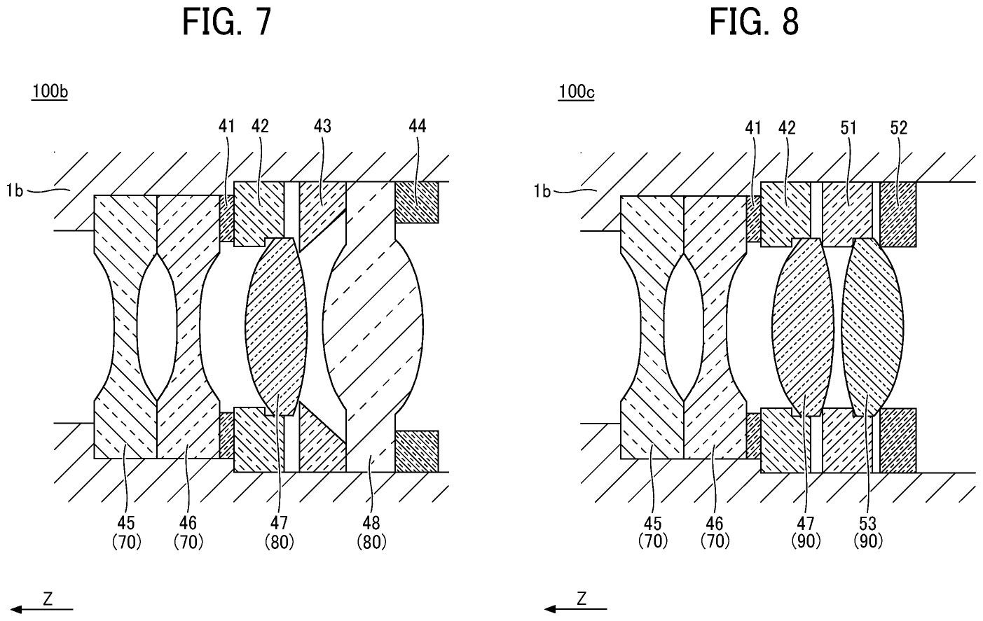

FIG. 7 is a cross-sectional view of a configuration of a lens unit 100b in a longitudinal direction according to a first example of the third embodiment. The lens unit 100b includes a first lens group 70, a second lens group 80, an elastic member 41, a first intervening member 42, a second intervening member 43, and a pressing member 44. The first lens group 70 includes a first lens 45 and a second lens 46. The second lens group 80 includes a third lens 47 and a fourth lens 48.

The first lens 45, the second lens 46, the elastic member 41, the first intervening member 42, the third lens 47, the second intervening member 43, the fourth lens 48, and the pressing member 44 are housed in the lens barrel 1b in this order from the positive Z-direction to the negative Z-direction.

The pressing member 44 has a screw portion at an outer portion of the pressing member 44. The lens barrel 1b has a screw portion at a part of an inner portion in the negative Z-direction. Each member housed in the lens barrel 1b is fixed by coupling the screw portions of the pressing member 44 and each screw portion of the lens barrel 1b.

The first lens 45 and the second lens 46 supported by the elastic member 41 are the flat-reception lenses in which the surfaces substantially perpendicular to the optical axis A are pressed. In the third lens 47 pressed by the pressing member 44, one surface facing the elastic member 41 (i.e., facing the positive Z-direction) is a spherical surface, and the other surface facing the pressing member 44 (i.e., facing the negative Z-direction) is spherical surface. Thus, the third lens 47 is the inclination-reception lens. The fourth lens 48 pressed by the pressing member 44 is the flat-reception lens in which a surface substantially perpendicular to the optical axis A is pressed. The first intervening member 42 is fitted into the lens barrel 1b and works as a regulating member to regulate the length of the elastic member 41 in the direction along the optical axis A.

In some embodiments, the lens unit, further includes a light shielding member adjacent to the elastic member.

In some embodiments, in the lens unit, the second lens group includes: the inclination-reception lens; another flat-reception lens having a flat surface perpendicular to the axial direction to be pressed; and another intervening member between the inclination-reception lens and the another flat-reception lens, the another intervening member has a surface perpendicular to the axial direction, and the surface contacts the inclination surface of the inclination-reception lens.

In some embodiments, in the lens unit, the second lens group includes: the inclination-reception lens; another inclination-reception lens having an inclination surface inclined relative to the axial direction to be pressed; and another intervening member between the inclination-reception lens and the another inclination-reception lens, the another intervening member has a surface perpendicular to the axial direction, and the surface contacts the inclination surface of the inclination-reception lens.

For example, the first lens 45 and the second lens 46 are made of resin, and the lens barrel 1b is made of resin, for example, PPS. When the values of the variables and constants below are substituted int the expression (1) described above, the left side of the expression (1) is 0.045 and less than 0.1. Thus, the expression (1) is satisfied.
Elastic modulus of the elastic member 41: K=20 (N/mm)
Elastic force of the elastic member 41: F=12 (N)
Coefficient of linear expansion of the first lens 45: α1=60×10⁻⁶ (1/° C.)
Length of the first lens 45: L1=2.5 (mm)
Coefficient of linear expansion of the second lens 46: α2=66×10⁻⁶ (1/° C.)
Length of the second lens 46: L2=2.5 (mm)
Coefficient of linear expansion of the lens barrel 1b: α0=26×10⁻⁶ (1/° C.)
Length of the lens barrel 1a: L0=5 (mm)
Ambient temperature range: t=145 (° C.) (−40° C. to 105° C.)

The elastic member 41 includes a plate-shaped spring made of, for example, a metal material. Specifically, the elastic member 34 is a wave washer made of stainless steel (SUS). The wave washer has an outer diameter of 13 mm, an inner diameter of 9 mm, a thickness of 0.12 mm, the number of waves of three, a free length of 0.9 mm, and a length of 0.3 mm in a direction along the optical axis A of the elastic member 41 when the elastic member 41 is contracted at a constant rate.

When the pressing force of the pressing member 44 is set to 150 N, the pressing force is larger than the elastic force 12 N of the elastic member 41. Thus, the first intervening member 42 can abut against the lens barrel 1b. In the lens unit 100b, the same effect as that of the lens unit 100 according to the first embodiment can be obtained.

FIG. 8 is a cross-sectional view of a configuration of a lens unit 100c in a longitudinal direction according to a second example of the third embodiment. The lens unit 100c includes a second lens group 90, a second intervening member 51, and a pressing member 52. The second lens group 90 includes a third lens 47 and a fourth lens 53.

The first lens 45, the second lens 46, the elastic member 41, the first intervening member 42, the third lens 47, the second intervening member 51, the fourth lens 53, and the pressing member 52 are housed in the lens barrel 1b in this order from the positive Z-direction to the negative Z-direction.

The pressing member 52 has a screw portion at an outer portion of the pressing member 52. The lens barrel 1b has a screw portion at a part of an inner portion in the negative Z-direction. Each member housed in the lens barrel 1b is fixed by coupling the screw portions of the pressing member 52 and each screw portion of the lens barrel 1b.

In the fourth lens 53 pressed by the pressing member, one surface facing the elastic member 41 (i.e., facing the positive Z-direction) is a spherical surface, and the other surface facing the pressing member 52 (i.e., facing the negative Z-direction) is a spherical surface. Thus, the fourth lens 53 is the inclination-reception lens.

As in the lens unit 100b described above, when the second lens group 80 includes a flat-reception lens such as the fourth lens 48, the fourth lens 48 of the lens unit 100b receives a pressing force asymmetric with respect to the optical axis A from the third lens 47. Thus, when the ambient temperature around the lens unit changes, and the lens unit expands and contracts, the fourth lens 48 may move in the radial direction and be decentered.

As illustrated in FIG. 8, when the fourth lens 53, which is a spherical lens, is used instead of the fourth lens 48 in the lens unit 100b, the cost of the lens unit 100c can be reduced, and the movement of the fourth lens 53 in the radial direction can be reduced. Other effects are the same as those of the lens unit 100 according to the first embodiment.

When it is difficult to arrange the fourth lens 53, which is a spherical lens, due to layout restrictions, it is preferable to use a fourth lens having a shape that has little influence on the performance of the lens unit even if it moves in the radial direction.

The embodiments described above are described as examples and the present invention is not limited to the embodiments described above. The embodiments described above can be implemented in other various forms, and various combinations, omissions, replacements, and changes can be made without departing from the scope of the invention. These embodiments and modifications thereof are included in the scope and spirit of the invention, and are also included in the invention described in the claims and the equivalents thereof.

An embodiment of the present invention is as follows, for example.

In a first aspect, a lens unit includes: multiple lenses arranged in an axial direction along an optical axis, the multiple lenses including: a first lens group including a flat-reception lens having a flat surface perpendicular to the axial direction to be pressed; and a second lens group including an inclination-reception lens having an inclination surface inclined relative to the axial direction to be pressed, a lens barrel housing the multiple lenses inside the lens barrel; and an elastic member between the first lens group and the second lens group, the elastic member to support at least one of the multiple lenses in the lens barrel; and a pressing member to press the multiple lenses in the lens barrel.

In a second aspect, a lens unit includes: multiple lenes arranged in an axial direction along an optical axis; a lens barrel housing the multiple lenses inside the lens barrel;

an elastic member to support at least one of the multiple lenses in the lens barrel; and a pressing member to press the multiple lenses in the lens barrel. Herein, an expression (1) below is satisfied:

$$\vert K \times ( t \times ( {\sum }_{i = 1}^{n} ( α i \times Li ) - α 0 \times L 0 ) ) / F \vert < 0.1 , \qquad ( 1 )$$

where: K is an elastic modulus of the elastic member,
F is an elasticity force to press the multiple lenses by elasticity of the elastic member,
t is a range of ambient temperature in which the lens unit is allowed to use,
n is a number of multiple lenses pressed by the elastic member with the elastic force of the elastic member,
αi is a coefficient of linear expansion of each of the multiple lenses in the lens barrel pressed by the elastic member,
Li is each of a length of the multiple lenses in the axial direction,
α0 is a coefficient of linear expansion of the lens barrel, and
L0 is a length of the lens barrel in the axial direction.

In a third aspect, in the lens unit according to the second claim, the multiple lenses including: a first lens group including a flat-reception lens having a flat surface perpendicular to the axial direction to be pressed; and a second lens group including an inclination-reception lens having an inclination surface inclined relative to the optical axis to be pressed. The elastic member is between the first lens group and the second lens group.

In a fourth aspect, in the lens unit according to the first aspect or the second aspect, a length of the elastic member in the axial direction is constant in a state where the elastic member is pressed by the pressing member.

In a fifth aspect, in the lens unit according to any one of the first aspect to the fourth aspect, the inclination surface of the inclination-reception lens is spherical.

In a sixth aspect, the lens unit according to any one of the first aspect to the fifth aspect, further includes: an intervening member having a surface perpendicular to the axial direction, the surface contacting the elastic member. The intervening member supports the inclination-reception lens, the elastic member supports the inclination-reception lens via the intervening member, and the inclination-reception lens has the inclination surface facing the flat-reception lens of the first lens group and inclined relative to the axial direction.

In a seventh aspect, the lens unit according to any one of the first aspect to the sixth aspect, the multiple lens includes at least one resin lens.

In an eighth aspect, in the lens unit according to any one of the first aspect to the seventh aspect, the elastic member includes a flat spring containing a metal material.

In a ninth aspect, the lens unit according to any one of the first aspect to the eighth aspect, further includes a light shielding member adjacent to the elastic member.

In a tenth aspect, in the lens unit according to any one of the first aspect to the ninth aspect, the second lens group includes: the inclination-reception lens; another flat-reception lens having a flat surface perpendicular to the axial direction to be pressed; and another intervening member between the inclination-reception lens and the another flat-reception lens, the another intervening member has a surface perpendicular to the axial direction, and the surface contacts the inclination surface of the inclination-reception lens.

In an eleventh aspect, in the lens unit according to any one of the first aspect to the ninth aspect, the second lens group includes: the inclination-reception lens; another inclination-reception lens having an inclination surface inclined relative to the axial direction to be pressed; and another intervening member between the inclination-reception lens and the another inclination-reception lens, the another intervening member has a surface perpendicular to the axial direction, and the surface contacts the inclination surface of the inclination-reception lens.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2022-075143, filed on Apr. 28, 2022, in the Japan Patent Office, the entire disclosure of which is hereby incorporated by reference herein.

### REFERENCE SIGNS LIST

1, 1a, 1b, 1c Lens barrel
2 Front lens pressing member
3 Front lens shielding member
4 Front lens elastic member
5 First front lens spacer
6 Second front lens spacer
7, 34, 41 Elastic member
7a Support member
71a Region
8 Intervening members
9, 35, 44, 52 Pressing member
10 Front lens group
11, 36, 45 First lens
12, 37, 46 Second lens
13, 38, 47 Third lens
20 Rear lens group
21, 48, 53 Fourth lens
21a, 22a Flat portion
22 Fifth lens
23, 23a, 23a1, 23a2 Sixth lens
231 First spherical surface
232 Second spherical surface
23c Optical axis
30, 50, 70 First lens group
31, 42 First intervening member
32, 43, 51 Second intervening member
33 Light shielding member
40, 60, 80, 90 Second lens group
100, 100a, 100b, 100c Lens unit
A Optical axis
F0, F1, F2 Pressing force

1. A lens unit comprising:
multiple lenses arranged in an axial direction along an optical axis, the multiple lenses including:
a first lens group including a flat-reception lens having a flat surface perpendicular to the axial direction to be pressed; and
a second lens group including an inclination-reception lens having an inclination surface inclined relative to the axial direction to be pressed,
a lens barrel housing the multiple lenses inside the lens barrel; and
an elastic between the first lens group and the second lens group, the elastic to support at least one of the multiple lenses in the lens barrel; and
a structure to press the multiple lenses in the lens barrel.

2. A lens unit comprising:
multiple lenes arranged in an axial direction along an optical axis;
a lens barrel housing the multiple lenses inside the lens barrel;
an elastic to support at least one of the multiple lenses in the lens barrel; and
a structure to press the multiple lenses in the lens barrel,
wherein an expression (1) below is satisfied:
$$\vert K \times ( t \times ( {\sum }_{i = 1}^{n} ( α i \times Li ) - α 0 \times L 0 ) ) / F \vert < 0.1 , \qquad ( 1 )$$
where:
K is an elastic modulus of the elastic,
F is an elasticity force to press the multiple lenses by elasticity of the elastic,
t is a range of ambient temperature in which the lens unit is allowed to use,
n is a number of multiple lenses pressed by the elastic with the elasticity force of the elastic,
αi is a coefficient of linear expansion of each of the multiple lenses in the lens barrel pressed by the elastic,
Li is each of a length of the multiple lenses in the axial direction,
α0 is a coefficient of linear expansion of the lens barrel, and
L0 is a length of the lens barrel in the axial direction.

3. The lens unit according to claim 2,
wherein the multiple lenses including:
a first lens group including a flat-reception lens having a flat surface perpendicular to the axial direction to be pressed; and
a second lens group including an inclination-reception lens having an inclination surface inclined relative to the optical axis to be pressed,
wherein the elastic is between the first lens group and the second lens group.

4. The lens unit according to claim 1,
wherein a length of the elastic in the axial direction is constant in a state where the elastic is pressed by the structure to press.

5. The lens unit according to claim 1,
wherein the inclination surface of the inclination-reception lens is spherical.

6. The lens unit according to claim 1, further comprising:
an intervening structure having a surface perpendicular to the axial direction, the surface contacting the elastic,
wherein the intervening structure supports the inclination-reception lens, the elastic supports the inclination-reception lens via the intervening structure, and
the inclination-reception lens has the inclination surface facing the flat-reception lens of the first lens group and inclined relative to the axial direction.

7. The lens unit according to claim 1,
wherein the multiple lenses lens includes at least one resin lens.

8. The lens unit according to claim 1,
wherein the elastic includes a flat spring containing a metal material.

9. The lens unit according to claim 1, further comprising a light shield adjacent to the elastic.

10. The lens unit according to claim 1,
wherein the second lens group includes:
the inclination-reception lens;
another flat-reception lens having a flat surface perpendicular to the axial direction to be pressed; and
another intervening structure between the inclination-reception lens and said another flat-reception lens,
said another intervening structure has a surface perpendicular to the axial direction, and
the surface contacts the inclination surface of the inclination-reception lens.

11. The lens unit according to claim 1,
wherein the second lens group includes:
the inclination-reception lens;
another inclination-reception lens having an inclination surface inclined relative to the axial direction to be pressed; and
another intervening structure between the inclination-reception lens and said another inclination-reception lens,
said another intervening structure has a surface perpendicular to the axial direction, and
the surface contacts the inclination surface of the inclination-reception lens.
